(19) United States
(12) Patent Application Publication
(10) Pub. No.: US 2018/0244538 A1
(43) Pub. Date: Aug. 30, 2018

(54) APPARATUS FOR PREPARING STRUCTURED WATER

(71) Applicant: Devon Tassen, Millville, CA (US)

(72) Inventor: Devon Tassen, Millville, CA (US)

(21) Appl. No.: 15/444,843

(22) Filed: Feb. 28, 2017

(51) Int. Cl. C02F 1/00; F15D 1/00; C02F 1/48; B01F 5/00

(52) U.S. Cl. CPC C02F 1/005; F15D 1/009; C02F 2103/02; B01F 5/0057; C02F 1/482

(57) ABSTRACT

Systems and methods for the production of structured water.

### I. BACKGROUND OF THE INVENTION

The human body is composed primarily of water. The medical literature reports that in general human beings are comprised between 70% to 80% water. Further, the literature reports a requirement for humans of approximately two quarts of water per day to maintain hydration. Exercise and/or physical labor can greatly increase the hydration requirement by multiple quarts per day. These requirements speak to the importance of clean and healthy water.

Beyond the need for water, the ability of a body to efficiently and effectively absorb water adds an important metric in the assessment of water quality. The literature reports that between ⅔ and ¾ of Americans are chronically dehydrated. The literature further reports that a mere 2 percent drop in body water content can trigger fatigue and a reduction in mental faculties. The importance of high quality, safe and healthy water cannot be overstated.

Healthy water supplies are becoming more difficult to obtain from natural resources. Pollution of aquifers is increasing at an alarming rate and those that haven't been contaminated are now under continued duress. Several of our larger cities and many smaller ones continually struggle to pass clean water tests. The issues facing water supplies are exacerbated by ever aging infrastructure and the ever-increasing use of chemicals in water refining. This invention speaks to a simple apparatus capable of treating, revitalizing and structuring inferior water to a healthy and absorbable state.

### II. SUMMARY OF THE INVENTION

In a key embodiment, according to the invention, provides an efficient and effective system to treat, revitalize and structure water from water that can be characterized as inferior, diseased, deteriorated, polluted, and/or unhealthy. The water to be treated, revitalized and structured may include a variety of impurities and containments such as bacteria, larvae, algae, sediment, metal particles and other materials that commonly are attributed as pollutants in water. Further, the water to be treated could have undergone numerous water treatment cycles, which have reduced its ability to effectively hydrate or be effectively used by humans, animals and/or plants.

The invention in at least one embodiment comprises a system including: a flow of water; a conveyance tube or pipe with an inlet and outlet in which said water flows; a vortex module within said tubular system which results in a vortex movement of the water flowing through said tube or pipe and a magnet disk-pack module which provides a suitable magnetic field positioned around the vortex module which acts upon the flowing water enabling increased water treatment, revitalization and structuring.

In at least one embodiment, according to the invention, is a self-contained system that emulates nature's ability to renew and restore vitality to stressed, processed or otherwise unhealthy water. Similar to a meandering mountain stream, which through constantly varying flow conditions, relative to the entire flowing volume of water, energizes and restructures water. Though the description speaks primarily to water, it should be understood that other liquids (i.e. wine, juice, etc.) can benefit from the restructuring and revitalizing process described in this disclosure. It should be understood that the description of water should not be construed as a limitation, rather as an exemplary example of a liquid processed by the innovation.

The vortex module generates a continuous, highly energetic, concentrating, through-flowing vortex which accelerates liquid flow and causes the flowing liquid to decrease in temperature as the liquid progresses through the vortex module. In the vortex module, the liquid undergoes rotational and helical acceleration resulting in simultaneous mixing in innumerable micro-vortices, reciprocating compression and rarefaction, and shear stresses resulting in a high degree of elemental/molecular reorganization.

The aforementioned forces are amplified through the magnet module from which is induced a suitable magnetic field. Movement through said magnetic field further induces organization and separation of electrical charges, motion induced electrical charges and associated dissociative interactions. Alignment of particles and electromagnetic domains further structures and organizes the liquid as it passes through the magnetic module. The combination of helical fluid flow and magnetic field result in highly structured liquid.

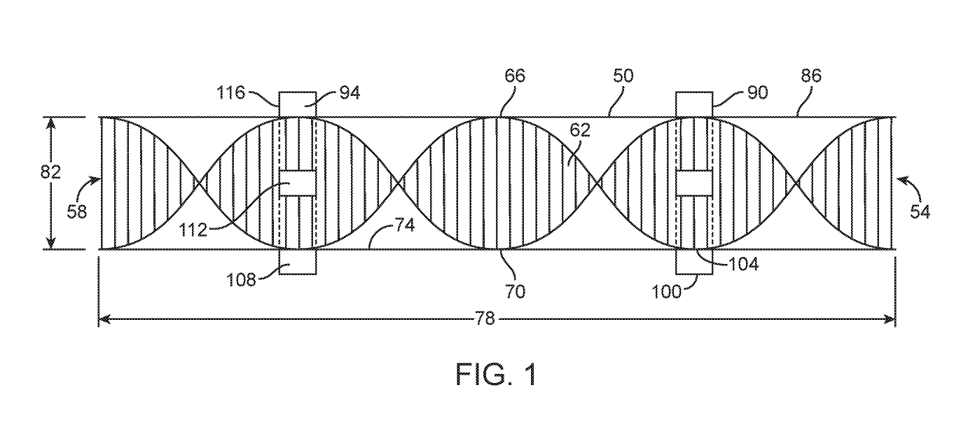

Referring to FIG. 1, which shows the apparatus for preparing structured water according to the present invention. A pipe (50) with an inlet (54) and outlet (58) on opposite ends of said pipe (50) as is known in the art. In a preferred embodiment, said pipe (50) is composed primarily of copper. Copper is known to have a variety of beneficial properties such as antimicrobial, antifungal, antibacterial action. Further, copper has exemplary electrical and magnetic properties, which provide efficient and effective energy transfer of the magnetic field produced by the magnetic disk assembly. Said magnetic disk assembly will be described later in this disclosure.

Further yet, copper is commonly used as a plumbing conveyance for water and other liquid based systems. Copper based plumbing systems and techniques to work with copper are well known in the art. Copper based apparatus for preparing structured water according to the present invention are designed such that they can be easily integrated into existing plumbing systems by standard means known in the art.

A helically twisted copper bar (62) is positioned in the pipe (50) such that both the top side of helically twisted copper bar (66) and bottom side of helically twisted copper bar (70) abut against the inner surface of said pipe (74). By helical, we refer to the twisting geometry, which physically characterizes the internal copper bar. Such bars can be produced by securing two opposite ends of a copper bar and rotating one end 360 degrees or more perpendicular to the axis separating the two secured opposite ends of the bar. Helical bars can also be produced by casting in a form of helical shape. The production of helical structures and bars, by the aforementioned methods and others is known in the art.

A tight fit between said helically twisted copper bar (70) and said inner surface of said pipe (74) results in an efficient and effective vortex action on water, or other liquid, which flows through said pipe (50). In a preferred embodiment, the tight fit produces a minimum of non-helical associated turbulence. Helical turbulence is defined as that turbulence produced by liquid flowing over a perfect helical surface placed within a pipe whose inner diameter is the same as the spherical diameter of the helix embodied by the helically twisted copper bar. Further, in a preferred embodiment, the tight fit results in the helical structure not changing position relative to the pipe (50).

In the specific embodiment shown in FIG. 1, said helically twisted copper bar (70) completes two complete rotations over the length of the vortex assembly (78). In this embodiment, the length of the vortex assembly (78) is 30″. The outer diameter (82) of said pipe (50), in this embodiment is 1″. Other pipe lengths and widths are contemplated and are amenable to the teachings of this patent application.

Magnet disk-pack modules are positioned on the outer surface of said pipe (86). In a preferred embodiment, a separate magnet disk-pack module is placed for each 360-degree rotation of flowing water. That is, a magnet disk-pack module is positioned such that a single magnet disk-pack module is placed at every 360-degree turn of the helically twisted copper bar (70) positioned within said pipe (50). It should be understood that said magnet modules can be on, in or part of said pipe. FIG. 1 shows a first magnet disk-pack module (90) and a second magnet disk-pack module (94) positioned such that they are placed at a distance from one another consistent with being one complete revolution of the helically twisted copper bar (70) apart.

In this embodiment, each magnet disk pack module is comprised of 4 individual magnets aligned such that their north poles (100) point away from said pipe (50) and their south poles (104) point towards said pipe (50). In this embodiment each magnet disk pack module has four magnets placed equidistant from one another around the circumference of said pipe (50) aligned along the same cross section of pipe. Magnet disk pack module (94) has a first magnet (108) a second magnet (112) a third magnet (116) and a forth magnet not visible as it placed on the far side of the pipe given the perspective of FIG. 1.

Magnetic field strengths are an important consideration in the practice of this innovation. Further, magnet assemblies should be positioned such that one magnet disk-pack module is placed for each complete revolution of the vortex module. Each individual magnet, in this embodiment, is substantially square with a length and width of 0.875″ and a height of 0.375″ and has a magnetic field strength of approximately 35 mega gauss per magnet. In preferred embodiments, magnets comprised of neodymium iron boron are preferred. Other size magnets and magnets composed of other chemical compositions can be used, provided the offer sufficient magnetic field strength.

Magnet disk-pack modules with different geometries have been effectively used in the practice of this innovation. For example, a magnet disk-pack module using disk magnets measuring 5/16″* 1/16″ with a magnetic field of 35 mega gauss for each used magnet, placed with the south poles facing the center of the 1″ outer diameter tubes was found to provide exemplary performance. In a further example successful magnet disk-pack modules have also been produced using block shaped magnets measuring as ⅞″*⅜″*2″, each magnet having a magnetic field strength of 35 mega gauss applied to a ¾″ and 1″ outer diameter tube. In a further example, a magnet disk-pack modules using block shaped magnets ⅞″*⅜″*2″, each magnet having a magnetic field of 7 mega gauss where found to provide exemplary performance applied to a ¾″ and 1″ outer diameter tube. In all the above cases, the pipes conveying the liquid measured no more than 1″ in diameter, with the average pipe width being ¾″.

If the technology taught in this innovation is to be practiced on larger diameter pipes, magnets with larger magnetic fields should be used to maintain the above described magnetic field to pipe diameter relationship. If magnets with smaller magnetic fields are used, the number of magnets used can be increased per magnet assembly, thereby providing the appropriate amount of magnetic field per pipe cross sectional area. Magnetic field strengths should be at least 0.75% of the above-defined magnetic field strength to pipe diameter relationship, magnetic fields less than 25% of the above-defined magnetic field strength to pipe diameter relationships are deemed to provide insufficient magnetic field strength for the practice of this technology.

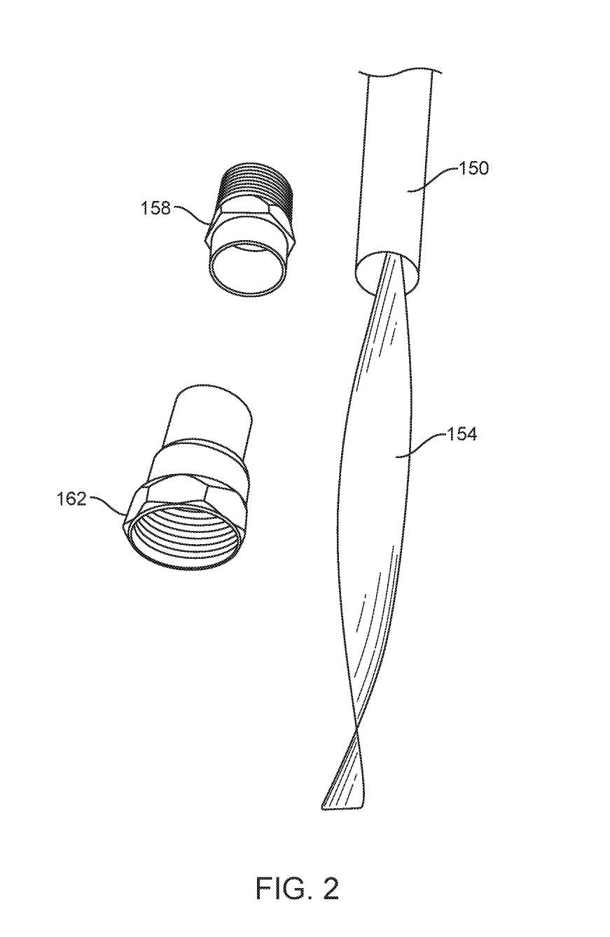

FIG. 2 shows a perspective view of a partially constructed apparatus for preparing structured water according to the present invention. A copper pipe (150) and a helically twisted copper bar (154) is shown where said helically twisted copper bar is partially inserted into said copper pipe (150). A male copper fitting (158) and a female copper fitting (162) of a size amenable to said copper pipe (150) are shown unattached to said copper pipe (150). Upon complete insertion of said helically twisted copper bar (154) and attachment of said male copper fitting (158) and a female copper fitting (162), the assembled water structuring device can be inserted into a liquid conveyance system by means known in the art. It should be noted that FIG. 2 does not show the magnet disk-pack module that would be applied prior to use in the field.

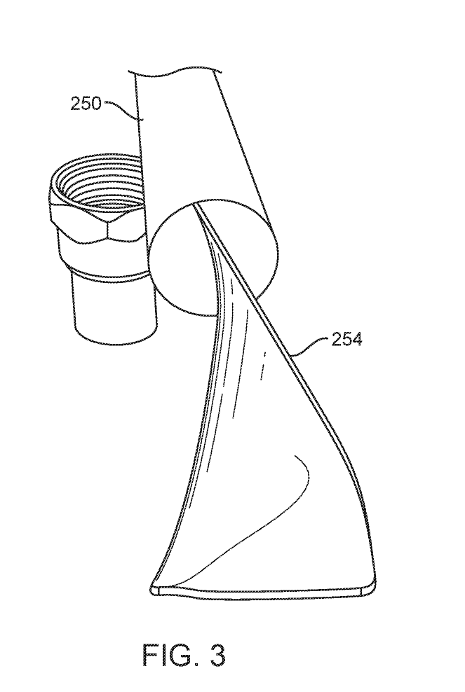

FIG. 3 shows an end on view of a partially constructed apparatus for preparing structured water according to the present invention. A copper pipe (250) viewed from one end can be seen with a helically twisted copper bar (254) shown partially inserted into said copper pipe (250). Said helically twisted copper bar (254) is smooth and fits snugly into said copper pipe (250) as previously described. FIG. 3 does not show the magnet disk-pack module that would be applied prior to use in the field.

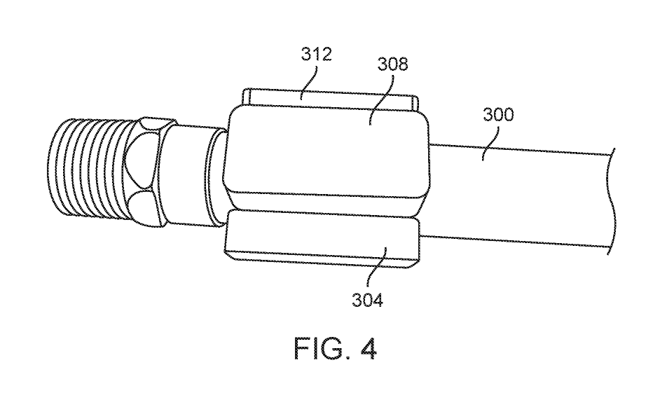

FIG. 4 shows a top view of an apparatus for preparing structured water according to the present invention. In this embodiment, 4 rectangular magnets, magnet (304), magnet (308), magnet (312) and a single magnet not visible from the perspective of FIG. 4, are positioned such that they are equally spaced along the circumference of the copper pipe (300) as previously described. The magnets are aligned along the same cross section of the pipe (300) and each have their north pole facing away from the pipe (300) and their south poles facing towards the pipe (300).

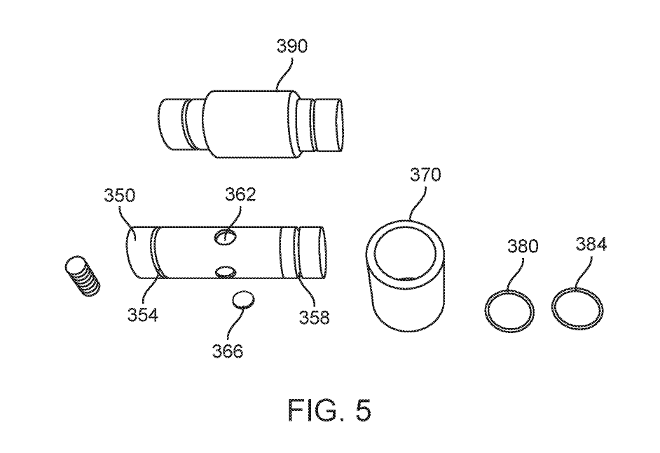

FIG. 5 shows a top view of an apparatus for preparing structured water according to the present invention using PVC pipe. A PVC pipe (350) is machined such that it has an O-ring groove (354) positioned close to one end of the PVC pipe (350) and second O-ring groove (358) positioned close to the opposite end of the PVC tube. Said PVC pipe (350) is further machined with a magnet recess (362) that has a width and depth such that it can accept and snuggly hold a magnet (366). That is, said magnet (366) is of a width and height slightly smaller than the width and height of said magnet recess (362) such that upon insertion to said magnet recess (362), the magnet does not move and maintains its position relative to the pipe (350).

As previously described, each magnet assembly is comprised of four magnets. In this embodiment, four magnet recesses are machined into the PVC pipe, equidistant from one another and aligned along a single cross section of pipe. In this embodiment, once the four magnets are positioned in their respective magnet recesses, a second PVC pipe (370) with an inner diameter slightly larger than the outer diameter of the PVC pipe (350) can be positioned on PVC pipe (350) over the magnet recesses, thereby securing the magnets in their recesses such that they cannot be dislodged without removing the second PVC pipe (370) from PVC pipe (350). A first O-ring (380) can be placed in the first O-ring groove (354) and a second O-ring (384) can be placed in the second O-ring groove (358) as is known in the art. A fully assembled apparatus for preparing structured water according to the present invention using PVC pipe (390) is also shown in FIG. 5.

### EXPERIMENTAL SECTION

Prototypes built according to the invention have been employed in a variety of test and validation experiments, both directly and indirectly, to determine in part whether the invention works for its intended purpose. To date, water-structuring systems have been built primarily from PVC and Copper as structural materials. Other materials such as copper alloys, silver, silver alloys, ceramics, metalorganic materials, plastics, metals and metal alloys are amenable and can be applied to the teachings of this patent application.

Efficacy testing have been primarily based structuring of city tap water, residential well water, and well water sources. Efficacy testing has been primarily based upon plant studies, animal studies, physical characterization and human trials.

Testing has resulted in treated, revitalized and structured water that has exhibited a variety of characteristics depending upon the specific design of the prototype evaluated to process the water, where the prototype has been built according to the invention. Water processed by embodiments of the innovation exhibited increased alkalinity, reduction in temperature, reduction in the amount of dissolved Oxygen, reduction in the size of dissolved oxygen bubbles, reduction in amount of dissolved solids, reduction in the ability to refract infra red light, reduction in resulting crystal structure upon freezing, imparted increased growth and fruit bearing in plants and a qualitative increase in hydration when consumed by humans. In embodiments, which utilized copper as a structural material, antimicrobial, antiviral and antibacterial action was noted as is known in the art. By art in this instance, we refer to the known antimicrobial, antiviral and antibacterial action associated with copper and copper ions.

The processed water has been shown to not be harmful to pets/animals such as fish, pets, etc. as these animals have thrived. An example of this is that animals including birds and other wildlife are drawn water sources containing processed water. Pets and other animals invariably will drink the processed water over water that has not been processed. When a prototype was operated in a chicken coop, four out of four chickens preferred to drink water produced by prototype constructed where the according to the invention.

Crystalline structures have been present in virtually all processed water microscopically observed. Frozen processed water becomes ultra-clear, with a luminous crystalline appearance and a minimum of visual residue. When observed under a microscope, it is apparent that the crystalline appearance is due to the presence of fine and consistent crystalline structures within the frozen water.

The invention in at least one embodiment was produced using PVC pipe of a size amenable to easy incorporation to a standard drinking bottle. A pipe 3″×0.840″ made out of PVC with four neodymium magnets around the center line with their south poles facing towards the center with a PVC tube covering them. The ends of the unit fit inside a drinking bottle size from 12 oz to a 2 L. This allows a user to structure their water where ever they are. By causing the water to freely go into a vortex spin and pass through a magnetic field at the same time this is done in one operation. As the inside diameter is consistent on most standard drinking bottles, 0.840″, said PVC unit readily fits securing in the 0.840″ opening.

### Plants

This invention is designed to restructure water to its natural state, and so can be more readily assimilated into biological cell structures in a manner similar to that of natural spring water. Water treated by a structured water apparatus according to the present invention has been shown beneficial for vegetation growth, in some cases better than 20% greater than standard irrigation supply.

In a plant test conducted Aug. 2-Aug. 20, 2015, pepper plants showed marked increase in growth and productivity when fed with structured water. All plants prior to the test where measured to be approximately 16″ in height. All plants were planted in identical pots with the same soil mix. Plants were located in full sun areas and received the same amount of water per plant. Pots 1 and 2 received structured water, while control plants in pots 3 and 4 received plain, untreated well water. Control pots showed no significant increase in height and bore no fruit during the course of this test. The control plants did form blossoms and new buds in the last 10 days of the testing period. Those plants that received structured water had 1″ and 2″ increases in height when compared to the control samples and produced one fruit and three fruits respectively along with multiples blossoms and new buds throughout the evaluation period. After 30 days growth, the control plants produced zero fruit and one small fruit respectively while those plants fed with structured water produced 1 fruit and three fruits respectively with the fruit being characterized as large and healthy looking.

Characterization of temperature changes as a function vortex assembly length was also performed on an apparatus for preparing structured water according to the present invention. The structured water assembly used in this specific test can be characterized as having an inner diameter of 0.750″, the vortex chamber had a length of 30″ with one complete 360 revolution of the helically twisted copper bar every 10″. That is, over the total 30″ length, the helically twisted copper bar completed 3 complete revolutions. In these serious of tests, a stable inlet water temperature was measured as 88.2 F at the inlet of the vortex chamber. At 1.5 full revolutions of the vortex assembly, 15″ downstream from the inlet, stabilized water temperatures where measured as 74.2 F, a 14 F drop in temperature. At the outlet of the vortex chamber, that is 30″ downstream from the inlet a stable temperature was measured as 72.4 F, a 16 F drop in temperature. By stabilized we refer to the measurement temperature being consistent over a 30 second interval plus or minus 0.1 F. The non-linear temperature drop over the length of the vortex chamber is a predictable and repeatable attribute of the innovation.

Flow through the vortex chamber is also an important attribute of the innovation. In particular, the amount of flow directly impacts the amount of resulting temperature change. Using a 0.750″ copper pipe as a conveyance tube, with a vortex chamber of a length of 30″ where the vortex chamber had three full twists over said 30″ was found to drop the temperature of the water by 5 degrees F. at a flow rate of 15 gallons per minute (gpm) (app. 10.8 feet per sec), a drop of 6 degrees F. at a flow rate of 4.6 gpm (app. 3.3 feet per sec) and a drop of 1 degree F. at a flow rate of 2.8 gpm (2.03 feet per sec). In preferred embodiments, 10 gallons per minute through a 0.750″ copper pipe will perform in an exemplary manner.

It will be apparent to those skilled in the art that various modifications and variations can be made in the apparatus for preparing hexagonal water of the present invention without departing from the spirit or scope of the invention. Thus, it is intended that the present invention cover the modifications and variations of this invention provided they come within the scope of the appended claims and their equivalents.

What is claimed is:

1. An apparatus for preparing structured water, comprising:
a pipe having an intake end and an outlet end;
a vortex chamber comprised of a helically twisted bar positioned within said pipe such that liquid flowing through said pipe and over said helically twisted bar follows the curvature of the helically twisted bar;
at least one magnet assembly comprised of magnetic materials orientated such that the north pole of the magnetic materials points away from said pipe and the south poles of said magnetic materials points towards said pipe;
where said magnet assembly is positioned on the outside of the circumference of said pipe in a position that coincides with the position of said vortex chamber in said pipe.

2. The apparatus of claim 1, where said pipe is comprised of copper.

3. The apparatus of claim 1, where said pipe is comprised of a copper alloy.

4. The apparatus of claim 1, where said pipe is comprised of PVC.

5. The apparatus of claim 1, where said pipe is 1″ in diameter plus or minus ¼″.

6. The apparatus of claim 1, where said pipe is comprised of a metal, metal alloy, ceramic, glass, metalorganic or combination thereof.

7. The apparatus of claim 1, where said helically twisted bar is comprised of copper.

8. The apparatus of claim 1, where said helically twisted bar is comprised of a copper alloy.

9. The apparatus of claim 1, where said helically twisted bar is comprised of a metal, metal alloy, ceramic, glass, metalorganic or combination thereof.

10. The apparatus of claim 1, where at least one of said magnet assembly is positioned on the outside of said pipe for every complete revolution of said helically twisted bar.

11. The apparatus of claim 1, where said magnet assembly is comprised of four magnets, each individual magnet having a magnetic field strength of 35 mega gauss plus or minus 15 mega gauss.

12. The apparatus of claim 1, where said magnet assembly provides a magnetic field strength of at least 80 mega gauss.

13. The apparatus of claim 1, where said magnet assembly provides a magnetic field strength of 140 mega gauss plus or minus 15 mega gauss.

14. The apparatus of claim 1, where the flow of liquid is 15 gallons per minute plus or minus 10 gallons per minute through said pipe and said pipe is between ½″ and 1.5″ in diameter.

15. An apparatus for preparing structured water, comprising:
a pipe with an inner diameter of 1″ plus or minus ¼″ composed of copper, copper alloy or pvc having an intake end and an outlet end;
a vortex chamber comprised of a helically twisted bar composed of copper or a copper alloy is positioned within said pipe such that liquid flowing through said pipe and over said helically twisted bar follows the curvature of the helically twisted bar;
at least one magnet assembly comprised of magnetic materials orientated such that the north pole of the magnetic materials points away from said pipe and the south poles of said magnetic materials points towards said pipe;
where said magnet assembly is positioned on the inside of the circumference of said pipe in a position that coincides with the position of said vortex chamber in said pipe.

16. The apparatus of claim 15, where at least one of said magnet assembly is positioned on the inside of said pipe for every complete revolution of said helically twisted bar.

17. The apparatus of claim 15, where said magnet assembly provides a magnetic field strength of at least 80 mega gauss.

18. The apparatus of claim 15, where said magnet assembly provides a magnetic field strength of 140 mega gauss plus or minus 15 mega gauss.
